(19) United States
(12) Patent Application Publication
(10) Pub. No.: US 2022/0206451 A1
(43) Pub. Date: Jun. 30, 2022

(54) SYSTEM HAVING A CONTROLLER AND HAVING AN ACTUATOR AND ALSO HAVING AN ASSEMBLY FOR PROVIDING FUNCTIONAL SAFETY

(71) Applicant: Ellenberger & Poensgen GmbH, Altdorf (DE)

(72) Inventors: Tobias PREM, Lauterhofen (DE); Philipp SCHMIDT, Nuernberg (DE)

(73) Assignee: Ellenberger & Poensgen GmbH, Altdorf (DE)

(21) Appl. No.: 17/697,635

(22) Filed: Mar. 17, 2022

Related U.S. Application Data
(63) Continuation of application No. PCT/EP2020/075364, filed on Sep. 10, 2020.

(30) Foreign Application Priority Data
Sep. 17, 2019 (DE) 10 2019 214 118.8
Oct. 21, 2019 (DE) 10 2019 216 196.0

(51) Int. Cl. G05B 19/048; G05B 9/03; G05B 19/4062; H02H 3/05

(52) U.S. Cl. CPC G05B 19/048; H02H 3/05; G05B 19/4062; G05B 9/03

(57) ABSTRACT

A system with a controller and with an actuator as well as with an assembly for providing functional safety. The assembly has a switching unit, which is inserted into an electrical supply line of the actuator and is operated via a control device of the assembly, which is connected to the controller in terms of signal technology. The invention further relates to an assembly and a switching unit.

This nonprovisional application is a continuation of International Application No. PCT/EP2020/075364, which was filed on Sep. 10, 2020, and which claims priority to German Patent Application No. 10 2019 214 118.8, which was filed in Germany on Sep. 17, 2019, and German Patent Application No. 10 2019 216 196.0, which was filed in Germany on Oct. 21, 2019 and which are all herein incorporated by reference.

### BACKGROUND OF THE INVENTION

### Field of the Invention

The present invention relates to a system with a controller and with an actuator as well as with an assembly. The assembly serves to provide functional safety and comprises a switching unit and a control device. Furthermore, the invention relates to an assembly and a switching unit.

### Description of the Background Art

Plants, such as industrial plants, usually have one or a plurality of actuators, via which an activity is carried out. In an industrial plant, for example, the actuator is used to create and/or process a workpiece. In order to operate the actuator according to the desired function, a controller is provided, via which a current supply to the actuator is set. In the simplest case, a switch is provided, which is actuated via the controller. The switch is used to switch the actuator on and off. For this purpose, the switch is inserted into an electrical supply line of the actuator. In this case, the switch, the controller and the actuator form a system.

If the actuator is used to carry out functions that could endanger other machines and/or operating personnel, it is necessary to provide functional safety. Thus, in an emergency, the intended function of the actuator is to be set and a safe state is to be assumed. Depending on the desired safety level, it is necessary to take into account possible faults in the system. In most cases, a possible failure of individual components of the system is also taken into account, e.g. of the switch. Therefore, it is necessary to insert a further switch into the supply line, which switch is also actuated via the controller, and which switch serves as a fallback solution. Furthermore, since it is also possible that excessive electrical voltage and/or current fluctuations occur in a supply network comprising the supply line, or that the actuator has a malfunction, it is necessary to insert a circuit breaker into the supply line, which thus serves as a line circuit breaker and/or as an equipment circuit breaker. In most cases, this is also actuated by the controller.

Thus, a total of three individual components have to be actuated via the controller in order to achieve the desired safety level. In this case, it is necessary to interconnect the individual components accordingly, which leads to increased assembly time. Also a comparatively large number of different lines/cables are required, which increases manufacturing costs. Additionally, it is necessary to match the individual components to each other for the intended application.

If one of the components does not meet a corresponding requirement, the complete plant with the system does not meet the desired safety level and must therefore not be operated. Consequently, even when designing the system, it is necessary to coordinate the individual components with each other, which leads to an extended projection time and thus also to increased manufacturing costs.

If the plant and the system have a plurality of actuators, a corresponding number of switches and cabling is required for each of these actuators. Since each of the switches is operated by the controller, a comparatively large number of interfaces for the switches has to be provided on the controller, which increases the manufacturing costs and the space required excessively.

### SUMMARY OF THE INVENTION

It is therefore an object of the present invention to specify a particularly suitable system with a controller and with an actuator as well as with an assembly and a particularly suitable assembly as well as a particularly suitable switching unit, wherein advantageously a production is simplified and expediently an assembly time and/or production costs are reduced, and wherein in particular safety is increased.

The system is, for example, a component of a plant, via which a specific function is carried out. In particular, the plant is an industrial plant and is used, for example, for the production and/or processing of a specific workpiece. The system has a controller and an actuator. The actuator is, for example, an electric motor, which is, for example, a rotating electric motor or a linear motor. Alternatively, the actuator is, for example, a valve that is electrically actuated. The actuator has a supply line, via which electrical energy is supplied. In the assembled state, the supply line is electrically contacted with a supply network that provides, for example, an electrical DC or AC voltage. The supply line is suitable, expediently provided and designed for this purpose. During operation, an electrical current of between 0.5 A and 20 A, between 1 A and 15 A or 2 A and 10 A is normally carried via the supply line, for example. In particular, in this case, the electrical supply line is at an electrical potential, which electrical potential has an electrical voltage to ground greater than 10 V, 20 V, or 100 V. For example, the electrical voltage is less than 10 kV, 5 kV or 1 kV. In particular, the electrical voltage is a DC voltage or an AC voltage.

The controller is provided via a computer, for example, and is in particular a programmable logic controller. In particular, process parameters for controlling the actuator are stored in the controller, wherein the actuator carries out a desired function if it is operated according to the process parameters.

Furthermore, the system has an assembly, which serves to provide functional safety. In other words, the assembly ensures that the safety integrity of the system is guaranteed. In particular, a certain safety level is guaranteed via the assembly. The assembly comprises a switching unit and a control device. The switching unit is inserted into the electrical supply line of the actuator, and via the switching unit it is thus possible to interrupt as well as to adjust an electrical current flow via the electrical supply line. In particular, the switching unit has a housing, within which all further components of the switching unit are arranged. Preferably, one of the walls of the housing has a connection to the supply line. In other words, the connection projects through the housing, so that the supply line can be connected to the switching unit. In particular, the connection merges into a strand of the switching unit arranged inside the housing.

The switching unit is operated via the control device of the assembly. In other words, the switching unit is operated via the control device. For example, the control device is used to control a supply current/supply voltage of the switching unit is set directly. In particular, however, commands are transmitted from the control device to the switching unit during operation, which commands are evaluated via the switching unit. This reduces the amount of cabling required between the control device and the switching unit. The control device is connected to the controller in terms of signal technology. In particular, the signal connection of the actuator to the controller is effected via the assembly, and a direct connection of the control device with the actuator does expediently not exist. To operate the actuator, the controller thus transmits a corresponding signal to the control device of the assembly, via which signal the switching unit is operated accordingly.

Thus, only one connection of the assembly to the actuator, namely the insertion into the electrical supply line, and of the controller to the assembly, is required to manufacture the system, which simplifies production. In summary, there are only comparatively few connections between the components of the system, which is why assembly time and manufacturing costs are reduced. Space requirements are also reduced. Since functional safety is also provided via the assembly, it is not necessary to coordinate individual components of the assembly with each other, which avoids incorrect coordination of individual components of the system and thus increases safety. It is also ensured that a certain safety level is realized, namely the one provided by the assembly. During operation, process parameters and/or instructions are transmitted to the assembly, in particular via the controller, and are received there via the control device. In dependence thereon, the switching unit is actuated, so that the actuator is operated according to the process parameters.

For example, the system has a plurality of such assemblies, each of which is connected via the controller in terms of signal technology. Each of the assemblies is preferably assigned at least one actuator, which actuator is operated via the respective assembly via the respective switching unit. In this case, the actuators and/or the assemblies are preferably not connected to each other directly, but always via the controller, which reduces cabling effort and increases interchangeability.

In particular, a certain safety level is ensured via the assembly. If the safety level of the system is to be changed, it is in particular only necessary to replace the assembly, for which only a certain number of lines or the like have to be reconnected. Thus, the effort required to increase or change the safety level is reduced. It is also not necessary to match individual components to each other, since this has already been done via the assembly. For example, the assembly additionally comprises a power supply. During operation, said power supply is used in particular to supply the control device and/or the switching unit and any further components of the assembly. Thus, fail-safety is further increased. It is also not necessary to dispense with a certain range of functions when manufacturing the control device, for example because the electrical energy required for this is not sufficient.

For example, the switching unit, suitably the possible strand, has only a single switch. Particularly preferably, however, the switching unit, suitably the possible strand, comprises a number of switching elements electrically connected in series, which are inserted into the supply line. Thus, in particular, 2, 3, 4 or more switching elements are present. When one of the switching elements is opened, the electrical current flow through the supply line is interrupted. Thus, even if one of the switching elements fails, it is still possible to interrupt the flow of electric current, which further increases safety.

At least one of the switching elements, preferably two or a plurality of the switching elements, are suitably designed as a mechanical switch, i.e. as an electromechanical switch. By applying a corresponding electrical voltage to the mechanical switch, the latter is opened/closed. In particular, the mechanical switch is designed as a relay or contactor. For example, one of the mechanical switches is designed as a relay and the other as a contactor, or both mechanical switches are designed as contactors or both mechanical switches are designed as relays. Due to the mechanical switches, a galvanic isolation takes place especially when opening, which is why a safety is further increased. In this case, in particular, the switch section or another component serves as a physical insulator. Suitably, an electrical insulator, for example made of a plastic or a ceramic, is inserted between any opening contacts of the mechanical switch. In summary, an additional physical insulator is thus provided. Thus, skipping of a spark and/or formation of an arc between the opening contacts is avoided, which further increases safety. If the mechanical switch is designed as a relay, said relay is expediently a monostable relay. Said monostable relay is preferably designed in normally open configuration. Thus, an active control is required to close the mechanical switch. In the event of a fault and/or when the power supply is interrupted, the mechanical switch is thus open, which increases safety.

Alternatively or particularly preferably in combination therewith, at least one of the switching elements is a semiconductor switch, for example a field effect transistor. Preferably, the semiconductor switch is a power semiconductor switch, such as a MOSFET, IGBT or GTO. In case of the semiconductor switch, no arcing occurs upon actuation, so that safety is increased. The semiconductor switch is expediently self-blocking. Consequently, conducting current via the semiconductor switch is only possible in the actuated state. Therefore, a current flow via the semiconductor switch is excluded in case of a defective activation, and thus in case of a fault, and/or in case of an interrupted power supply, which increases safety. Expediently, the semiconductor switch is designed to be monostable.

Preferably, both the semiconductor switch and at least one mechanical switch are provided. In this case, when the switching unit is actuated and transferred to the electrically non-conductive state, expediently, the semiconductor switch is opened first and then the mechanical switch or switches are opened. Thus, no arcing occurs at the mechanical switches, which prevents damage. Heat generation is also reduced. It is thus possible to carry out a comparatively large number of switching operations via the switching unit. When the switching unit is transferred to the electrically conductive state, all mechanical switches are actuated first, followed by the semiconductor switch. In this way, the formation of an arc or the like is also prevented in this case, which reduces wear.

The switching unit expediently has a current limiter, via which the maximum electric current carried by the switching unit is limited. The current limitation is expediently active, so that the current flow is or respectively can be maintained for a certain period of time, for example indefinitely, with the maximum conducted electric current. Exceeding the maximum conducted electric current, on the other hand, is essentially not possible. In particular, the value of the maximum conducted electric current is adapted to the current application. Preferably, the current limitation is implemented via a semiconductor whose electrical resistance increases with increasing electrical current, the increase being expediently non-linear. Preferably, the semiconductor switch, if present, is used as current limiter, and the semiconductor switch is designed accordingly. Thus, in particular when approaching the maximum electric current to be conducted via the switching unit, the ohmic resistance of the semiconductor switch is increased, preferably substantially abruptly. For example, the maximum electrical current that can be conducted due to the current limitation is between 8 A and 12 A or between 9 A and 11 A. Due to the current limitation, safety is thus also increased in the event of a fault, for example in the event of a short circuit in the actuator, and expected destruction or further damage is reduced.

Particularly preferably, the switching unit comprises an electrical fuse, which is electrically connected in series with the switching element(s) and which is thus also inserted into the supply line. The fuse is in particular independent of the use and/or design of the switching elements and is expediently always inserted into the supply line. In particular, the fuse is designed as a safety fuse, for example as a so-called glass tube fuse or the like. In the event of an excessive electric current, the fuse interrupts the flow of electric current via the switching unit, so that the fuse acts as a “fail safe” element. In the event of a comparatively extensive failure of individual components of the system, for example also of individual components of the switching unit, the fuse ensures that the operation of the actuator is interrupted. Thus, a safety level is increased. In an alternative, one or a plurality of circuit breakers are used instead of the fuse.

For example, all switching elements are actuated via the control device, via which control device a corresponding supply voltage is applied to the individual switching elements. Particularly preferably, however, the switching unit has a control unit, via which the switching element or respectively the switching elements are actuated. In this case, the control device transmits corresponding signals to the control unit, via which the switching elements are actuated accordingly. Via the control unit, a corresponding supply voltage is expediently applied to the switching elements for this purpose. This further reduces the amount of cabling required. The control unit expediently has two parts, which are redundant to each other. In this case, a corresponding control of the switching elements is made possible via each of the parts. Consequently, even if one of the parts of the control unit fails, further operation is possible, which further increases safety. For example, the two parts are of the same design relative to each other or, particularly preferably, of different design. In particular, different manufacturers are used in this case for the individual components, so that in the event of defective manufacture of the components of one of the parts, in particular microprocessor, continued operation is possible with the other part.

Particularly preferably, the switching elements are designed in such a way that they provide feedback as to which switching state they are in. If the respective switching element is a mechanical switch/relay, it expediently comprises auxiliary contacts that serve to provide feedback. For example, the auxiliary contacts are always in electrical contact with each other when current flow is possible via the respective switching element. If the current flow is not possible, the auxiliary contacts are expediently also separated from each other, or vice versa respectively. The auxiliary contacts are preferably forcibly guided and designed, for example, as so-called mirror contacts. If the respective switching element is designed as a semiconductor switch, the signal applied to a gate (gate signal) is used as feedback, for example. In a further development, the feedback is additionally derived on the basis of a current flow via the semiconductor switch and/or an insulating capacity of the semiconductor switch. In an alternative, the electrical current flowing across the semiconductor switch is detected, for example measured, for feedback. Alternatively or in combination, the applied electrical voltage is detected, for example measured. In summary, the function of the semiconductor switch is monitored (“monitoring”).

The feedback is read out directly via the control device, for example. Particularly preferably, the control unit or a further control unit is provided in this case, via which the corresponding state of the switching elements is read out. The state is preferably transmitted as a signal to the control device. This further reduces the amount of cabling required. It is also possible to draw conclusions about the current state of the actuator on the basis of reading out the state of the switching elements. Alternatively, or particularly preferably in combination therewith, the switching unit has a sensor, via which the electric current conducted via the switching unit and/or the applied electric voltage is detected. In other words, the switching unit comprises a current sensor and/or a voltage sensor. Preferably, this sensor is also read out by the control unit, and in dependence thereon, for example, one of the switching elements or a plurality of the switching elements is actuated. Preferably, actuation takes place in dependence on a limit value being exceeded by the applied electrical voltage and/or the electrical current conducted therewith and/or as a function of a change in the electrical current/voltage within a certain period of time. Thus, the switching unit additionally assumes the function of a circuit breaker, in particular a line circuit breaker or equipment circuit breaker. Thus, safety is further increased.

Preferably, the actuator comprises a ground line, which has ground, in particular earth, as electrical potential during operation. For example, a housing of the actuator is electrically contacted with the ground line, so that a contact protection is realized. Preferably, the switching unit comprises an additional switching element, which is inserted into the ground line of the actuator. Thus, the ground line is also guided via the switching unit. During operation, the additional switching element is in particular also actuated via the possible control unit. Due to the additional switching element, it is thus possible to also electrically interrupt the ground line and thus electrically disconnect the actuator both from ground and from the electrical potential, against which the supply line is guided. Thus, a safety level is increased. In an alternative embodiment, the additional switching element does not exist and thus the ground line in particular is intact. For example, the ground line is at least partially provided via the switching unit, or the ground line is not part of the switching unit.

For example, a plurality of such additional switching elements are inserted into the ground line, which increases safety. For example, at least one of the additional switching elements is designed as a mechanical switch, and another of the additional switching elements is designed as a semiconductor switch. Preferably, however, there is only one additional switching element, which reduces manufacturing costs. Preferably, said switching element is designed as a mechanical switch, so that galvanic isolation and therefore electrical insulation is provided when the additional switching element is opened.

Expediently, the system has a further actuator, which is, for example, identical in construction to the actuator. In particular, the two actuators interact, so that they are operated in coordination with each other via the controller. Alternatively, the two actuators are independent of each other, for example, and each of the actuators is used to process/create a different workpiece. The further actuator has a further supply line.

In particular, the switching unit has a number of further switching elements electrically connected in series, which are inserted into the further supply line. Thus, the switching unit also carries the electrical current, via which the further actuator is energized. For example, the further switching elements are substantially identical in construction to the possible switching elements, so that the switching unit has two strands, which are identical in construction to each other, one of the strands being assigned to the supply line and the further strand being assigned to the further supply line. In particular, a further fuse is present here, which is inserted into the further supply line. If the control unit is present, the further switching elements are expediently also actuated via it. In other words, the switching unit has only a single control unit, via which all switching elements or the like are actuated, and/or via which all possible sensors, at least one of which is preferably assigned to each of the lines, are read out. Thus, hardware requirements are reduced. In a further development, a corresponding circuit breaker is used instead of the further fuse.

In an alternative thereto, the assembly has a further switching unit, which is identical in construction to the switching unit. However, the further switching unit is inserted into the further supply line, so that the electrical current carried by the further supply line can be interrupted via the further switching unit. Furthermore, the further switching unit is operated via the control device. Thus, both the switching unit and the further switching unit are operated via the control device. Due to the further switching unit, a modular structure of the system is realized, so that a comparatively large number of further actuators can be operated via the system. Preferably, a plurality of further actuators are thus present. For example, part of each of these is assigned to one of the further switching units, with further switching elements being assigned to the switching unit or the further switching units in each case, for example. In other words, at least two or a plurality of the actuators are operated with each of the switching units of the assembly. Thus, a total number of switching units is reduced.

The control device and the switching unit are preferably only connected to each other in terms of signal technology, so that only signals are exchanged between them. Expediently, said signals only have a certain electrical voltage level, which is why processing is extended. Preferably, the control device and the switching unit are connected via a first bus system in terms of signal technology. The control device is configured as a master of the first bus system. The switching unit is thus a slave. If there are a plurality such switching units, for example the further switching unit, these are all configured as slaves in particular. Since the assembly has only a single control device, which is always present, unambiguous identification of the master is facilitated. Also, it is thus possible to use a comparatively large number of separate switching units. In particular, the switching unit is connected to the control unit in terms of signal technology, if said control unit is present.

Preferably, the control device and/or the switching unit has a plurality of connections, each of which is connected to a corresponding line of the first bus system. Thus, a redundancy of the signal connection is realized. Preferably, the first bus system complies with a Profibus, Profinet, Ethercat, Ethernet IP or IO Link standard, with safety-related functions being suitably supported, for which a safety layer is provided in particular. Preferably, the bus standard used for the first bus system is Profisave, Safety over Ethercat (FSoE), Safety over IO-Link or respectively CIP Safety. In particular, communication is sequential, so that a value identifying the previous telegram is processed with each telegram sent. This ensures that the telegrams exchanged via the first bus system are received correctly by each of the participants in the first bus system, i.e. the master and the slaves.

Alternatively, or particularly preferably in combination therewith, the control device and the controller are connected via a second bus system in terms of signal technology. In this case, for example, the control device is configured as a slave of the second bus system, and the controller is expediently configured as the master of the second bus system. Thus, a modular structure is also provided, so that a plurality of assemblies can be used. In this case, each control device of the assemblies is expediently configured as a slave. Preferably, the second bus system complies with a Profibus, Profinet, Ethercat, Ethernet IP or IO Link standard, wherein safety-relevant functions are suitably supported, for which in particular a safety layer is provided. Preferably, the bus standard used for the first bus system is Profisave, Safety over Ethercat (FSoE), Safety over IO-Link or CIP Safety. Suitably, the control device and the controller each have a plurality of connections, which are assigned to different, parallel lines. Thus, a redundant signal connection between the control device and the controller is also provided.

Particularly preferably, both the first and the second bus system are present. Since in this case the switching unit is connected to the control device via the first bus system, precise knowledge of the structure of the switching unit is not required in the controller. Also, a number of participants in the second bus system is reduced, since in the second bus system, no address is assigned to the switching unit, in particular to the possible control unit, but only in the first bus system. Thus, it is possible to increase a cycle time in the second bus system and also in the first bus system, and thus a speed of data exchange. Also, when the assembly is replaced, it is not necessary to change the programming of the controller, which simplifies maintenance. Additionally, if an error occurs in the first bus system, a repercussion on the second bus system and thus on the controller is avoided, so that any further assemblies can continue to be operated safely. In other words, a feedback effect on further components of the system is reduced. Thus, safety is increased.

If a plurality of switching elements are present, in particular the two mechanical switches and/or the semiconductor switch, a switching group is expediently formed via these. Suitably, the switching group comprises all strands of the switching unit, thus also the possible further and/or additional switching elements, so that the switching unit is formed via the possible control device and the switching group, which has the individual switching elements. Suitably, the possible fuse and/or further fuses are each a component of the switching group. The switching group is suitably implemented as a single assembly.

During operation of the system, actuation of the actuator is specified via the system. If the actuation takes place depending on a process parameter, this is suitably transmitted to the switching unit. If the switching unit has switching elements or the like, one of which has a safety level greater than a limit value and the other of which has a safety level less than the limit value, for example the mechanical switch and the semiconductor switch, the switching element having the lower level, i.e. in particular the semiconductor switch, is expediently actuated. However, if the controller specifies that the actuator is to be actuated due to a certain safety function, for example STO (safe torque off), the switching element with the highest safety level or at least the switching element whose safety level is higher than the limit value is actuated, in particular the mechanical switch. In this case, expediently, the semiconductor switch is actuated first and following this the mechanical switch, so that the formation of an arc is prevented.

The assembly serves to provide functional safety and is suitable, in particular provided and designed to be used in a system that also has a controller and an actuator. In the assembled state, a switching unit of the assembly is inserted into an electrical supply line of the actuator. Furthermore, the assembly has a control device, via which the assembly is operated. The assembly is further suitable, in particular provided and designed to be connected to the control device in terms of signal technology. In particular, for this purpose, the control unit comprises a suitable circuit, which is implemented, for example, via a number of electrical and/or electronic components. Preferably, the circuit is of redundant design, with different manufacturers preferably being used for the individual parts/components. Thus, fail-safety is further increased. In particular, the control device has a number of interfaces for connection with the controller and/or further components of the system in terms of signal technology.

The switching unit is suitable, in particular intended, to be inserted into an electrical supply line of an actuator. Moreover, the switching unit is a component of an assembly, which serves to provide functional safety. Preferably, the switching unit has a housing, within which all further components of the switching unit are arranged, in particular possible switching elements and/or a fuse. Preferably, the switching unit has a control unit arranged in the housing. The control unit is expediently of redundant design and preferably has two parts. Each of the parts is, for example, an application specific integrated circuit (ASIC). The housing is preferably made of a plastic or a metal and, in the assembled state, is expediently electrically contacted with ground and is thus suitable, in particular provided and designed for this purpose. Thus, a contact protection is realized.

The further developments and advantages explained in connection with the system are also to be applied analogously to the assembly/switching unit and to each other, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic sketch of a system with a controller and with an actuator as well as with an assembly,

FIG. 2 shows the system according to FIG. 1, with a further actuator and a modified switching unit of the assembly, and

FIG. 3 shows the system according to FIG. 2, with a further switching unit.

### DETAILED DESCRIPTION

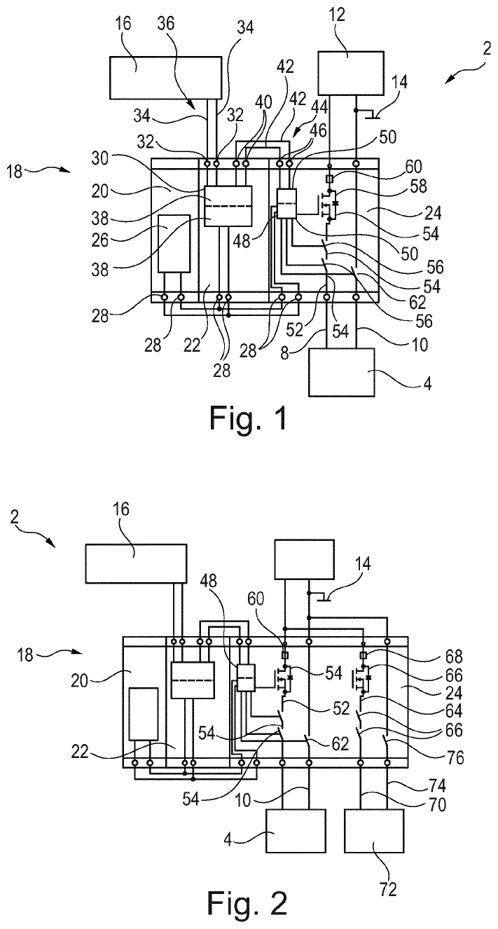

FIG. 1 shows a schematic sketch of a system 2, which is a component of an industrial plant not shown in more detail. The system 2 has an actuator 4 in the form of an electromechanical valve, via which a flow of a fluid, such as a gas or a liquid, through a pipe is controlled. The actuator 4 has a supply line 8 and a ground line 10, which are electrically contacted with a supply network 12. In this example, the supply network 12 is provided via a rectifier not shown in more detail. The ground line 10 is also electrically connected to ground 14. A constant electrical potential is guided via the supply line 8 and the ground line 10, with an electrical voltage of 200 V being applied between them.

Furthermore, the system 2 has a controller 16, in which process parameters for actuating the actuator 4 are stored, so that a suitable control/regulation of the fluid supply takes place. The controller 16 is a programmable logic controller and via this a control and/or regulation of further components of the industrial plant not shown in more detail, such as of further machines and/or actuators, which are not shown in more detail here, takes place.

Furthermore, the system 2 has an assembly 18, which serves to provide functional safety. The assembly 18 has a power supply 20, a control device 22 and a switching unit 24, which are each designed as assemblies that can be lined up together and are arranged in a control cabinet, which is not shown in more detail. The switching unit 24 is designed as a separate component, which can be detached from the control device 22 for assembly and/or replacement purposes. The power supply 20 has a power source 26, via which a DC electrical voltage of 24 V is provided. The power source 26 is guided against two power connections 28 of the power supply 20, which are electrically connected to respective corresponding power connections 28 of the control device 22 and of the switching unit 24, so that an electrical supply is provided to the control device 22 and to the switching unit 24 via the power supply 20.

The control device 22 has a control module 30, which is electrically supplied via the power connection 28. Furthermore, the control module 30 is connected to the controller 16 in terms of signal technology via two second connections 32 of the control device 22, each via a second bus line 34 of a second bus system 36. Due to the two second bus lines 34 and the two second connections 32, redundancy is provided. The second bus system 36 complies with the Profisafe or Safety over 10 Link standard, and the controller 16 is configured as the master of the second bus system 36. The control device 22, in particular the control module 30, is configured as a slave of the second bus system 36. If a plurality of such assemblies 18 are present, each control device 22 is configured as a respective slave of the second bus system 36.

To provide fail-safety, the control module 30 has two subsections 38, which carry out the same functions, but are provided via mutually different circuitry. In other words, the control module 30 also is of redundant design. The control module 30 is connected to corresponding connections 46 of the switching unit 24 via two first connections 40, each via a first bus line 42 of a first bus system 44 assigned there. Thus, a redundant signal connection between the control device 22 and the switching unit 24 is also implemented here. A control unit 48, which has two parts 50, is connected to the connections 46 in terms of signal technology. The two parts 50 carry out the same functions during operation, so that the control unit 48 also has a redundant structure. Power is supplied to the control unit 48 via the power connections 28.

In summary, the control device 22, namely the control module 30, and the switching unit 24, namely the control unit 48, are connected via the first bus system 44 in terms of signal technology, which is operated in accordance with the Profisafe or Safety over 10 Link standard. In this case, the control device 22 is configured as a master and the switching unit 24 is configured as a slave of the first bus system 44. In other words, communication in the first bus system 44 is specified via the control device 22. The first bus system 44 is in this case independent of the second bus system 36, and the switching unit 24 is not assigned an address in the second bus system 36.

The switching unit 24 has a strand 52, which is inserted into the supply line 8. In other words, during operation via the strand 52, part of the electrical energy is conducted from the supply network 12 to the actuator 4, and the switching unit 24 is inserted into the supply line 8. The strand 52 has a total of three switching elements 54, which are electrically connected in series. Two of the switching elements 54 are configured as a mechanical switch 56. The mechanical switch 56 is a contactor. The remaining switching element 54 is a semiconductor switch 58 in the form of a MOSFET. The semiconductor switch 58 also acts as a current li-miter. When an electric current of 10 A is exceeded, the ohmic resistance of the semiconductor switch 58 increases, so that the electric current cannot further increase. Thus, via the semiconductor switch 58, a protection of the actuator 4 as well as of other components of the switching unit 24 takes place. In summary, the switching elements 54 are inserted into the supply line 8 and are electrically connected in series.

The switching elements 54 are actuated via the control unit 48. For this purpose, a respective electrical supply voltage is applied to the switching elements 54 via the control unit 48, so that they are in the electrically conductive or electrically non-conductive state. Moreover, the switching elements 54 are designed in such a way that, by applying an electrical voltage to them, it can be queried as to which switching state they are in. The state of the switching elements 54 is also interrogated via the control unit 48.

Furthermore, a fuse 60 is inserted into the strand 52, which fuse 60 is thus electrically connected in series with the switching elements 54. The fuse 60 is configured as a glass tube fuse. The fuse 60 serves as a final protection in case, for example, a fault occurs in the control unit 48, the semiconductor switch 58, which acts as a current limiter, or other components of the switching unit 24. When the fuse 60 is tripped, it is destroyed and thus the strand 52 is disconnected. As a result, an electrical power supply to the actuator 4 from the supply network 12 is interrupted.

The ground line 10 also runs through the switching unit 24, which is thus inserted into the ground line 10 of the actuator 4. An additional switching element 62, which in this example is designed as a mechanical switch, namely as a contactor, is inserted into the ground line 10, so that this can also be interrupted. The additional switching element 62 is also actuated via the control unit 48, wherein, moreover, the state of the additional switching element 62 can be interrogated.

During operation, a request for actuation of the actuator 4 is transmitted from the controller 16 via the second bus system 36 to the control device 22 of the assembly 18. For this purpose, a safe protocol is used, and the request is generated based on the execution of a safe function, namely STO (“safe torque off”), for example. The request is processed via the control module 30 and first verified. Subsequently, it is derived therefrom which of the switching elements 54 is to be actuated. It is also verified whether the additional switching element 62 is to be actuated. When the actuator 4 is to be disconnected from the supply network 12, the command is transmitted via the second bus system to the control unit 48 to actuate first the semiconductor switch 58 and subsequently after that the mechanical switches 56 of the strand 52. Following this, the additional switching element 62 is to be actuated. The corresponding request is received via the control unit 48 and verified by the latter. Following this, the semiconductor switch 58 is first transferred to the electrically non-conductive state via suitable application of an electrical voltage thereto. When this is done, the mechanical switch 56 is opened via the control unit 48, for which purpose a suitable electrical voltage is applied thereto. Following this, the additional switching element 62 is actuated and thus the ground line 10 is also disconnected. As a result, the actuator 4 is completely galvanically isolated from the supply network 12. Due to the sequence, no electric arc is generated at the mechanical switches 56 and also at the additional switching element 62, which is why a comparatively large number of switching operations can be carried out.

If the process parameters specify that the actuator 4 is energized, a corresponding request is transmitted to the control device 22 via the controller 16. There, the request is first verified, and following this, via the control module 30, the request is transmitted to the control unit 48 to first close the additional switching element 62 and subsequently to close the mechanical switch 56. Following this, the semiconductor switch 58 is to be transferred to the electrically conductive state. Thus, also in this case, the formation of an arc is prevented, and following this the actuator 4 is electrically contacted with the supply network 12. Thus, the switching unit 24 is operated via the control device 22.

Furthermore, the switching unit 24 has sensors not shown in more detail, via which the electrical current conducted via the strand 52 and the electrical potential conducted therewith are monitored. The sensors are read out via the control unit 48 and are, for example, integrated into the switching elements 54 or at least one of the switching elements 54 or are a separate component. If the electric current and/or the electric potential and/or a respective change thereof is greater than a certain limit value, at least one of the switching elements 54, in particular all of the switching elements 54, is actuated via the control unit 48, so that they are transferred to the electrically non-conductive state. Thus, the switching unit 24 also acts as a circuit breaker.

Since the control module 30, the bus systems 36, 44 and the control device unit have a redundant design and a plurality of switching elements 54 are present, the assembly 18 fulfills a certain safety level, wherein the individual components of the assembly 18 are matched to each other. During assembly, only a comparatively small amount of cabling is required.

In a variant of the system 2 shown in FIG. 1, which is not shown in more detail, the semiconductor switch 58 and/or the fuse 60 are not present.

FIG. 2 shows a modification of the assembly 18, in which only the switching unit 24 is modified. The switching unit 24 has a further strand 64, which is identical in construction to the strand 52. Thus, the further strand 64 has three further switching elements 66, one of which corresponds to each of the switching elements 54, and which are electrically connected to each other accordingly. The further switching elements 66, two of which are mechanical switches and one of which is a semiconductor switch in the form of a MOSFET, are also actuated via the control unit 48, and via the control unit 48 a state of the further switching elements 66 during operation is also read out. Further, a further fuse 68 is provided in the further strand 64, which carry out the same function in the further strand 64 as the fuse 60 in the strand 52.

The further strand 64 is inserted into a further supply line 70 of a further actuator 72. The further actuator 72 further has a further ground line 74, into which the switching unit 24 is also inserted. Thus, the switching unit 24 has a further additional switching element 76 corresponding to the additional switching element 62. The further ground line 74 is guided against ground 14 and is suitably contacted with the ground line 10 for this purpose. In this case, the further additional switching element 76 is arranged between the further actuator 72 and the electrical connection with the ground line 10.

During operation, the further switching elements 66 and the further additional switching element 76 are also actuated via the control unit 48 in dependence of requests/commands specified on the part of the controller 16. The electrical current/the respective electrical potential applied via the further line 64 and the further ground line 74 is also monitored.

In a variant of the system 2 shown in FIG. 2, which is not shown in more detail, the further fuse 68 is not present. Also, for example, the further strand 64 is free from semiconductor switches, with the strand 52 having the semiconductor switch 58. In a further alternative, the strand 52 also does not have the semiconductor switch 58.

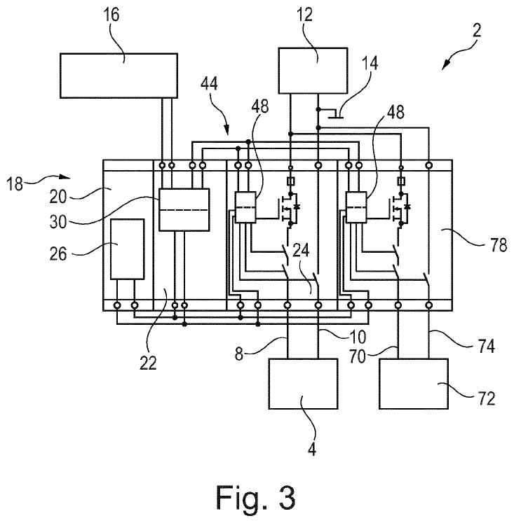

FIG. 3 shows a further variation of system 2, where the assembly 18 is based on the embodiment shown in FIG. 1. Thus, the switching unit 24 and the power supply 20 are unchanged. However, just as in the embodiment shown in FIG. 2, the further actuator 72 is present, which has the further ground line 74 as well as the further supply line 70. Additionally, there is a further switching unit 78, which is constructed in the same way as the switching unit 24. However, the further switching unit 78 is inserted into the further supply line 70 as well as the further ground line 74. The switching unit 24 is only inserted into the supply line 8 as well as the ground line 10. Thus, one of the switching units 24, 78 is assigned to each of the actuators 4, 72.

The further switching unit 78 is also electrically connected to the power source 26 of the assembly 18 and is thus supplied with electrical energy via the power supply 20. The first bus system 44 is also extended, so that both switching units 24, 78 are now connected to the control device 22 in terms of signal techno-logy. In this case, the two switching units 24, 78 are each configured as a slave.

If a request/command to change the operation of the actuators 4, 72 is created via the control device 22, this is received via the control device 22 and verified there. Following this, the control module 30 determines, which of the switching units 24, 78 is to be actuated. Depending on this, a corresponding command, as already described for FIG. 1, is fed to the respective control unit 48 in the first bus system 44. Thus, both switching units 78 are actuated by means 24,of the control device 22.

The invention is not limited to the embodiments described above. Rather, other variants of the invention can also be derived therefrom by expert without leaving the object of the invention. Furthermore, in particular, all individual features described in connection with the individual embodiment examples can also be combined with each other in other ways without leaving the object of the invention.

What is claimed is:

1. A system comprising:
a controller;
an actuator; and
an assembly for providing functional safety, the assembly having a switch, which is inserted into an electrical supply line of the actuator and is operated via a control device of the assembly, which is connected to the controller in terms of signal technology.

2. The system according to claim 1, wherein the switch has a number of switching elements, which are electrically connected in series and are inserted into the supply line.

3. The system according to claim 2, wherein two of the switching elements are each a mechanical switch.

4. The system according to claim 2, wherein one of the switching elements is a semiconductor switch.

5. The system according to claim 1, wherein the switch has a fuse, which is electrically connected in series with the switching elements.

6. The system according to claim 2, wherein the switch has a control unit, via which the switching elements are actuated.

7. The system according to claim 1, wherein the switch has an additional switching element, which is inserted into a ground line of the actuator.

8. The system according to claim 1, further comprising a further actuator with a further supply line, the switch having a number of further switching elements, which are electrically connected in series and are inserted into the further supply line or the assembly having a further switching unit, which is inserted into the further supply line and is operated via the control device.

9. The system according to claim 1, wherein the control device and the switch are connected via a first bus system in terms of signal technology, the control device being configured as a master of the first bus system.

10. The system according to claim 1, wherein the control device and the controller are connected via a second bus system in terms of signal technology, the control device being configured as a slave of the second bus system.

11. An assembly for providing functional safety according to claim 1.

12. A switching unit according to claim 1.
